(19) United States
(12) Patent Application Publication
(10) Pub. No.: US 2025/0372699 A1
(43) Pub. Date: Dec. 4, 2025

(54) DESIGN PRINCIPLE OF SOLID ELECTROLYTE FOR HIGH-VOLTAGE ALL-SOLID-STATE BATTERY AND UTILIZATION THEREOF

(71) Applicant: KOREA INSTITUTE OF SCIENCE AND TECHNOLOGY, Seoul (KR)

(72) Inventors: Seungho Yu, Seoul (KR); Hun-Gi Jung, Seoul (KR); Kyung Yoon Chung, Seoul (KR); Yongheum Lee, Seoul (KR)

(21) Appl. No.: 19/015,425

(22) Filed: Jan. 9, 2025

(30) Foreign Application Priority Data
Jun. 4, 2024 (KR) 10-2024-0073217

(51) Int. Cl. H01M 10/0562; C01F 17/36; H01M 4/13; H01M 10/0525

(52) U.S. Cl. CPC H01M 10/0562; C01F 17/36; H01M 4/13; H01M 10/0525; C01P 2002/72; C01P 2006/40; H01M 2300/008

(57) ABSTRACT

A solid electrolyte for an all-solid-state battery designed from a first principle-based calculation and represented by the following Chemical Formula 1 is provided: [Chemical Formula 1] LiₙMCl₆₋ₓFₓ In Chemical Formula 1, M may be at least one trivalent metal among Al, Ga, In, Tl, Bi, Sc, Lu, Y, Yb, Tm, Er, Ho, Dy, Tb, Gd, Sm, Nd, and La, or at least one tetravalent metal among Ti, Zr, and Hf; n may have a value of 3 when M is a trivalent metal and have a value of 2 when M is a tetravalent metal; and x may have a value greater than 0 and less than or equal to 1.5.

### CROSS-REFERENCE TO RELATED APPLICATION(S)

This application claims the benefit of Korean Patent Application No. 10-2024-0073217, filed on Jun. 4, 2024, in the Korean Intellectual Property Office, the entire disclosure of which is incorporated herein by reference for all purposes.

### BACKGROUND

### 1. Field

One or more embodiments relate to a solid electrolyte for a high-voltage all-solid-state battery.

### 2. Description of Related Art

Lithium-ion batteries, currently the most popular energy storage devices, have already been used as indispensable power sources for mobile devices such as smartphones and laptops, because lithium-ion batteries may achieve high energy density while being lightweight. Currently, research is actively being conducted to apply lithium-ion batteries to a wide range of fields, from portable devices to transportation such as electric vehicles and large-capacity energy storage systems.

As part of such research, various approaches are being attempted to optimize the electrochemical performance and stability of lithium-ion batteries. In particular, all-solid-state batteries with introduced solid electrolytes are receiving attention as next-generation secondary battery candidates due to their potentially high energy density and enhanced stability. Specifically, in all-solid-state batteries, lithium metal anodes instead of graphite anodes may be used due to the introduction of solid electrolytes, to secure a high energy density, and safety-related issues of lithium-ion batteries may be extensively resolved by replacing liquid electrolytes having the inherent risk of explosion.

Among various types of solid electrolytes, which are core components of all-solid-state batteries, sulfide-based solid electrolytes have ionic conductivity greater than or equal to that of existing liquid electrolytes, and thus, related research has been actively conducted. However, sulfide-based solid electrolytes have issues, such as a reduction in electrochemical stability and oxidation stability, or a reaction of volatilized sulfur with a cathode. On the other hand, oxide-based solid electrolytes have relatively high electrochemical and chemical stability, but it is difficult to treat oxide-based solid electrolytes, additional sintering at a high temperature is inevitably performed, and resistance at a solid electrolyte interface is high.

Accordingly, lithium halide-based solid electrolytes have begun to receive attention as replacement candidates that may compensate for issues of existing solid electrolytes described above. Lithium halide-based solid electrolytes, especially lithium chloride-based (Li-M-Cl) solid electrolytes, have high oxidation stability and chemical stability because lithium chloride-based solid electrolytes have high ionic conductivity of about 10⁻⁴ S/cm and form a stable interface even when used with a cathode that exhibits relatively high voltage.

However, since lithium chloride-based solid electrolytes also have inherent issues of a decrease in suitability with cathode materials at high voltage of 4 V or greater, there is a need to develop a lithium halide-based solid electrolyte that has excellent oxidation stability even at high voltage and high ionic conductivity at room temperature by modifying or replacing the lithium chloride-based solid electrolyte.

### SUMMARY

One or more embodiments provide a solid electrolyte for an all-solid-state battery that is a lithium halide-based solid electrolyte in which chloride (Cl) is partially substituted with fluoride (F) and that is represented by the following Chemical Formula 1:

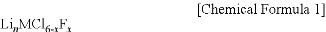

In Chemical Formula 1, M may be at least one trivalent metal among Al, Ga, In, Tl, Bi, Sc, Lu, Y, Yb, Tm, Er, Ho, Dy, Tb, Gd, Sm, Nd, and La, or at least one tetravalent metal among Ti, Zr, and Hf; n may have a value of 3 when M is a trivalent metal and have a value of 2 when M is a tetravalent metal; and x may have a value greater than 0 and less than or equal to 1.5.

However, goals to be achieved by the present disclosure are not limited to those described above, and other goals not mentioned above can be clearly understood by one of ordinary skill in the art from the following description.

According to an embodiment, a solid electrolyte for a lithium halide-based all-solid-state battery, which is a lithium halide-based solid electrolyte for an all-solid-state battery in which chloride (Cl) is partially substituted with fluoride (F), is provided. To solve the above problems, an optimal structure and anion substitution ratio according to a metal element may be effectively screened based on first-principle calculations, and a solid electrolyte for an all-solid-state battery with an optimal structure and components revealed from results of the screening may be provided.

Additional aspects of embodiments will be set forth in part in the description which follows and, in part, will be apparent from the description, or may be learned by practice of the disclosure.

According to embodiments, a solid electrolyte for an all-solid-state battery may have an excellent oxidation stability even at a high voltage and a high ionic conductivity at room temperature, by partially substituting chloride (Cl) with fluoride (F) in a lithium chloride-based solid electrolyte (Li-M-Cl) and by selecting an appropriate metal element (M).

It should be understood that the effects of the present disclosure are not limited to the effects described above, but include all effects that can be inferred from the configuration of the disclosure described in the detailed description or claims of the present disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating structural preferences and phase stabilities for different metal elements in a chloride-based solid electrolyte and a fluoride-based solid electrolyte according to an embodiment;

FIG. 2 is a diagram illustrating structural preferences according to a radius of each of a metal element and halogen in a chloride-based solid electrolyte and a fluoride-based solid electrolyte according to an embodiment;

FIG. 3 is a diagram illustrating results obtained by calculating decomposition energy according to a range of substitution with fluoride (F) in solid electrolytes having different metal elements according to an embodiment;

FIG. 4 is a diagram illustrating results obtained by calculating oxidation potentials of a chloride-based solid electrolyte and oxidation potentials of a chloride-based solid electrolyte in which Cl is partially substituted with F according to an embodiment;

FIG. 5 is a diagram illustrating results obtained by calculating an ionic conductivity according to a range of substitution with F in a chloride-based solid electrolyte according to an embodiment;

FIG. 6 is a diagram illustrating analysis results of isosurfaces of a lithium ion probability density function of an F-substituted chloride-based solid electrolyte according to an embodiment;

FIG. 7 is a drawing illustrating results of an X-ray diffraction (XRD) analysis for a solid electrolyte according to an embodiment;

FIG. 8 is a drawing illustrating analysis results of electrochemical impedance spectroscopy (EIS) for a solid electrolyte according to an embodiment;

FIG. 9 is a drawing illustrating analysis results of a cyclic voltammetry for a solid electrolyte according to an embodiment; and

FIG. 10 is a drawing illustrating analysis results of a discharge capacity of an all-solid-state battery according to an embodiment.

### DETAILED DESCRIPTION

Hereinafter, embodiments will be described in detail. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, components, and/or groups thereof but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In addition, when describing the embodiments, detailed description of well-known related structures or functions will be omitted when it is deemed that such description will cause ambiguous interpretation of the present disclosure.

Furthermore, the terms first, second, A, B, (a), and (b) may be used to describe components of the embodiments. These terms are used only for the purpose of discriminating one component from another component, and the nature, the sequences, or the orders of the components are not limited by the terms.

A component, which has the same common function as a component included in any one embodiment, will be described by using the same name in other embodiments. Unless disclosed to the contrary, the description of any one embodiment may be applied to other embodiments, and the specific description of the repeated configuration will be omitted.

It will be understood throughout the whole specification that, when one part “includes” or “comprises” one component, the part does not exclude other components but may further include the other components.

According to an embodiment, a solid electrolyte for an all-solid-state battery represented by the following Chemical Formula 1 may be provided:

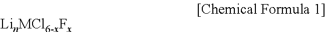

In Chemical Formula 1, M may be at least one trivalent metal among Al, Ga, In, Tl, Bi, Sc, Lu, Y, Yb, Tm, Er, Ho, Dy, Tb, Gd, Sm, Nd, and La, or at least one tetravalent metal among Ti, Zr, and Hf; n may have a value of 3 when M is a trivalent metal and have a value of 2 when M is a tetravalent metal; and x may have a value greater than 0 and less than or equal to 1.5.

In Chemical Formula 1, M may be at least one trivalent metal among Al, Ga, In, Tl, Bi, Sc, Lu, Y, Yb, Tm, Er, Ho, Dy, Tb, Gd, Sm, Nd, and La.

In the present disclosure, prior to a full scale experiment, to identify a crystal structure and an optimal anion substitution ratio (x) according to various metal element species (M) that may be included in the solid electrolyte, first-principle calculations to calculate physical properties and chemical properties of a specific material based on basic information of constituent elements and basic principles of quantum mechanics were utilized, to design a lithium halide-based solid electrolyte with optimal constituent element species and anion substitution range. Calculations were performed using a Vienna ab initio simulation package based on basic information on a total of “18” metal elements (M), that is, Al, Ga, In, Tl, Bi, Sc, Lu, Y, Yb, Tm, Er, Ho, Dy, Tb, Gd, Sm, Nd, and La, to predict chemical properties such as a phase stability, structural preference, ionic conductivity, and oxidation stability of the solid electrolyte. Therefore, chemical property prediction results based on various types of calculations and a design of a solid electrolyte based on the chemical property prediction results are described below.

In Chemical Formula 1, M may be at least one trivalent metal among In, Tl, Bi, Sc, Lu, Y, Yb, Tm, Er, Ho, Dy, Tb, and Gd.

A lithium halide-based solid electrolyte may have one of structures of C2/m, Pnma, and P-3m1. Since the above structures are known to be high ionic conductivity phases, the lithium halide-based solid electrolyte may be determined to be suitable for use as a solid electrolyte. In addition, when a phase stability of a solid electrolyte decreases, a decomposition into decomposition phases of LiX, MX₃, and LiMX₄ (X is F or Cl) may be performed. Since the above decomposition phases have extremely low ionic conductivities, the above decomposition phases may be determined to be relatively unsuitable for use as a solid electrolyte.

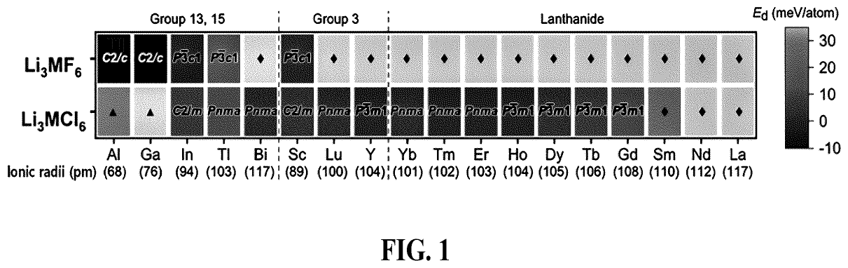

To predict a possibility of a synthesis or a stability of the solid electrolyte according to metal elements (M) based on the above description, a phase stability obtained from decomposition energy E_{d} calculated based on structural preferences and decomposition phases of Li₃MCl₆ and Li₃MF₆ for a total of “18” metal elements (M), that is, Al, Ga, In, Tl, Bi, Sc, Lu, Y, Yb, Tm, Er, Ho, Dy, Tb, Gd, Sm, Nd, and La is shown in FIG. 1.

Referring to FIG. 1, for Li₃MCl₆, it is predicted that as an ionic radius of M decreases, the structure of C2/m is formed, and that as the ionic radius of M increases, the structure of P-3m1 is formed. Since the above structures correspond to high ionic conductivity phases as described above, Li₃MCl₆ with above structures may be determined as a suitable candidate for a solid electrolyte. However, a decrease in a phase stability is predicted based on a decomposition into LiMCl₄ (▴ in Li₃MCl₆ row, FIG. 1) with a structure of P2₁/c, which is a decomposition phase, when M is Al, or Ga and a decomposition into LiMCl₄ (♦ in Li₃MCl₆ row, FIG. 1) with a structure of I41/a, which is a decomposition phase, when M is Sm, Nd, or La.

In addition, since Li₃MF₆ has the structure of C2/c or P-3c1 when M is Al, Ga, In, Tl, or Sc, a decrease in ionic conductivity in comparison to a chloride-based solid electrolyte is predicted. When M is metals other than the above five species, a decrease in a phase stability due to a decomposition into LiMF₄ (♦ in Li₃MF₆ row, FIG. 1) with the structure of I41/a is predicted.

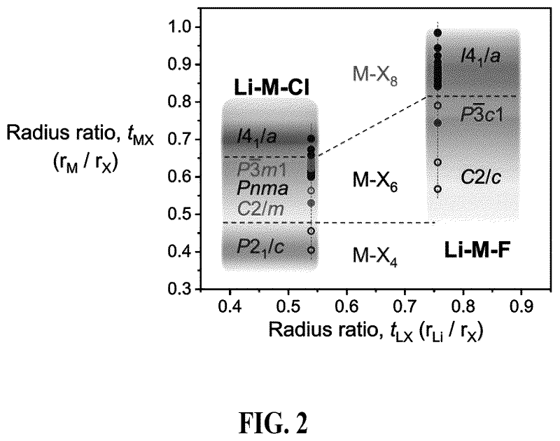

Therefore, results of listing structural preferences of lithium halide-based solid electrolytes according to a ratio (t_{MX}=r_{M}/r_{X}) of an ionic radius (r_{M}) of a metal element to an ionic radius (r_{X}) of halogen are shown in FIG. 2. Accordingly, it is predicted that a solid electrolyte having a structure (C2/m, Pnma, and P-3m1) exhibiting a high ionic conductivity may be synthesized when tux has a value of 0.52 to 0.65 in Li₃MCl₆.

In an example, M may be at least one trivalent metal among In, Tl, Bi, Sc, Lu, Y, Yb, Tm, Er, Ho, Dy, and Tb, and x may have a value greater than 0 and less than or equal to 1.5; or M may be Gd that is a trivalent metal, and x may have a value greater than 0 and less than or equal to 1.0. In this example, a value of decomposition energy E_{d} of the solid electrolyte may be less than or equal to 45 millielectron volts per atom (meV/atom).

In another example, M may be at least one trivalent metal among In, Tl, Bi, Sc, Lu, Y, Yb, Tm, Er, and Ho, and x may have a value greater than 0 and less than or equal to 1.5; or M may be at least one trivalent metal among Dy, Tb, and Gd, and x may have a value greater than 0 and less than or equal to 1.0. In this example, the value of the decomposition energy E_{d} of the solid electrolyte may be less than or equal to 40 meV/atom.

In another example, M may be at least one trivalent metal among In, Tl, Sc, Lu, Yb, Tm, and Er, and x may have a value greater than 0 and less than or equal to 1.5; or M may be at least one trivalent metal among Bi, Y, Ho, Dy, Tb, and Gd, and x may have a value greater than 0 and less than or equal to 1.0. In this example, the value of the decomposition energy E_{d} of the solid electrolyte may be less than or equal to 35 meV/atom.

In another example, M may be In that is a trivalent metal, and x may have a value greater than 0 and less than or equal to 1.5; or M may be at least one trivalent metal among Tl, Bi, Sc, Lu, Y, Yb, Tm, Er, Ho, and Dy, and x may have a value greater than 0 and less than or equal to 1.0; or M may be at least one trivalent metal among Tb and Gd, and x may have a value greater than 0 and less than or equal to 0.5. In this example, the value of the decomposition energy E_{d} of the solid electrolyte may be less than or equal to 30 meV/atom.

In another example, M may be at least one trivalent metal among In, Tl, Lu, Yb, Tm, and Er, and x may have a value greater than 0 and less than or equal to 1.0; or M may be at least one trivalent metal among Bi, Sc, Y, Ho, Dy, Tb, and Gd, and x may have a value greater than 0 and less than or equal to 0.5. In this example, the value of the decomposition energy E_{d} of the solid electrolyte may be less than or equal to 25 meV/atom.

Referring to FIGS. 1 and 2, it is predicted that a structure of Li₃MF₆ has an ionic conductivity and phase stability less than those of a structure of Li₃MCl₆, and accordingly, it is inferred that when a structure of Li₃MCl₆₋ₓFₓ is formed by substituting a portion of Cl in the structure of Li₃MF₆ with F, an appropriate substitution range (x), within which a possibility of a synthesis of a corresponding solid electrolyte or characteristics of an initial Li₃MCl₆ solid electrolyte may be maintained to some extent, is present.

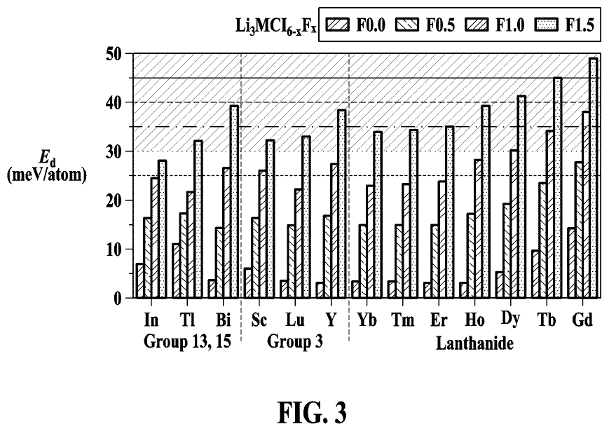

Accordingly, in a compound (in which M is In, Tl, Bi, Sc, Lu, Y, Yb, Tm, Er, Ho, Dy, Tb, or Gd) that is predicted not to be easily decomposed into a decomposition phase with reference to FIGS. 1 and 2, a value of decomposition energy E_{d} of a solid electrolyte in which Cl is partially substituted with F may be calculated based on the degree of substitution to obtain a phase stability, and the results thereof are shown in FIG. 3. Here, the value of the decomposition energy E_{d} may be calculated by thermodynamically calculating a difference in an energy value between decomposition phases relative to a target solid electrolyte. In an example of a Li₃MCl₆ solid electrolyte, an energy difference between 3LiCl and MCl₃ that are predicted decomposition phases may be thermodynamically calculated to obtain a value of decomposition energy E_{d}, and a positive number of the decomposition energy E_{d} may indicate that a solid electrolyte has a high energy in comparison to decomposition phases.

Referring to FIG. 3, by setting the type of M and the range of x in a compound with a value of decomposition energy E_{d} less than or equal to a value of a predetermined decomposition energy E_{d}, compounds may be classified based on phase stabilities. In general, decomposition energy E_{d} of 25 meV/atom is regarded as an energy level of a metastable phase, and a phase stability may be determined based on the value. However, this is not an absolute standard, and even if a specific compound has a value of decomposition energy E_{d} exceeding 25 meV/atom, a possibility of a synthesis through, for example, an introduction of a solid-state process such as a high-energy ball mill process and an optimization of a sintering temperature may be sufficiently high.

In an example, a value of decomposition energy E_{d} of a compound in which M is In, Tl, Bi, Sc, Lu, Y, Yb, Tm, Er, Ho, Dy, or Tb and x has a value greater than 0 and less than or equal to 1.5, or in which M is Gd and x has a value greater than 0 and less than or equal to 1.0 may be less than or equal to 45 meV/atom. In another example, a value of decomposition energy E_{d} of a compound in which M is In, Tl, Bi, Sc, Lu, Y, Yb, Tm, Er, or Ho and x has a value greater than 0 and less than or equal to 1.5, or in which M is Dy, Tb, or Gd and x has a value greater than 0 and less than or equal to 1.0 may be less than or equal to 40 meV/atom. In this example, a phase more stable than a compound with the value of decomposition energy E_{d} less than or equal to 45 meV/atom only may be formed.

In another example, a value of decomposition energy E_{d} of a compound in which M is In, Tl, Sc, Lu, Yb, Tm, or Er and x has a value greater than 0 and less than or equal to 1.5, or in which M is Bi, Y, Ho, Dy, Tb, or Gd and x has a value greater than 0 and less than or equal to 1.0 may be less than or equal to 35 meV/atom. In another example, a value of decomposition energy E_{d} of a compound in which M is In that is a trivalent metal and x has a value greater than 0 and less than or equal to 1.5, in which M is Tl, Bi, Sc, Lu, Y, Yb, Tm, Er, Ho, or Dy and x has a value greater than 0 and less than or equal to 1.0, or in which M is Tb, or Gd and x has a value greater than 0 and less than or equal to 0.5 may be less than or equal to 30 meV/atom. In another example, a value of decomposition energy E_{d} of a compound in which M is In, Tl, Lu, Yb, Tm, or Er and x has a value greater than 0 and less than or equal to 1.0, or in which M is Bi, Sc, Y, Ho, Dy, Tb, or Gd and x has a value greater than 0 and less than or equal to 0.5 may be less than or equal to 25 meV/atom, which may indicate that the compound has stable energy in comparison to the metastable phase, and thus, it may be predicted that it is relatively easy to perform a synthesis.

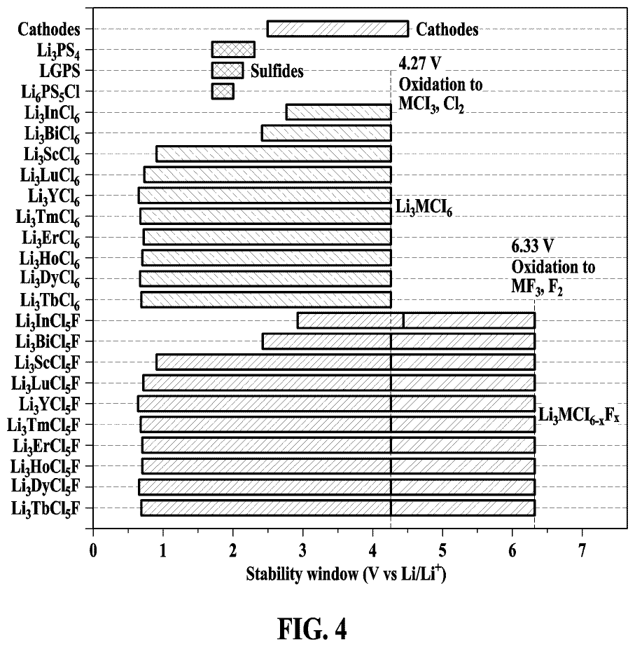

In addition to the results associated with the phase stability, electrochemical stabilities of Li₃MCl₆, and Li₃MCl₅F with one of Cl substituted by F for multiple metal elements (M) were calculated using a grand potential diagram, and the results thereof are shown in FIG. 4.

Referring to FIG. 4, Li₃MCl₆ has relatively high oxidation potentials of about 4.3 V, and thus it is predicted to have an oxidation stability even for cathode materials exhibiting relatively high voltage. In addition, it is confirmed that Li₃MCl₅F, in which one of Cl is partially substituted with F, may have a high oxidation potential of up to about 6.3 V due to a presence of a passive film formed by oxidative degradation into LiF and LiMF₄ at 4.3 V. Thus, it can be confirmed that if Cl in Li₃MCl₆ is partially substitutable with F, a solid electrolyte with an enhanced oxidation stability may be obtained in comparison to when Cl is not substituted.

According to an embodiment, in Chemical Formula 1 shown above, M is a trivalent metal, for example, Sc, Yb, or Y, and x may have a value greater than 0 and less than or equal to 1.5, desirably have a value between 0.5 and 1.5, and more desirably have a value between 1.0 and 1.5.

According to an embodiment, in Chemical Formula 1, M is a trivalent metal, for example, Y, and x may have a value greater than 0 and less than or equal to 1.5, desirably have a value between 0.5 and 1.5, more desirably have a value between 0.5 and 1.0, and most desirably have a value greater than 0.5 and less than or equal to 1.0.

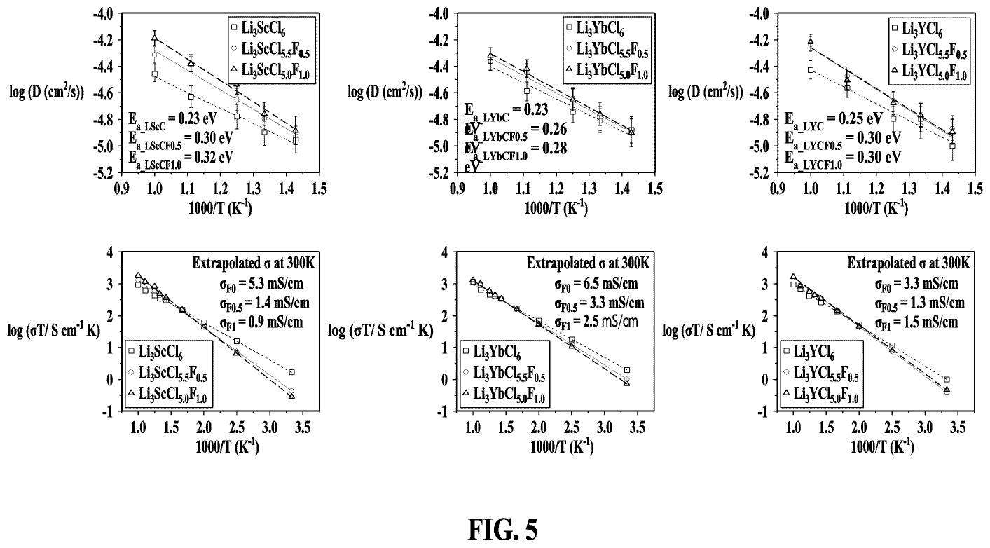

To predict ionic conductivities of solid electrolytes according to a degree of substitution with F, a lithium (Li)-ion diffusivity and Li-ion conductivity were calculated according to values of x in Li₃MCl₆₋ₓFₓ (M=Sc, Yb, Y) solid electrolytes having structures of C2/m, Pnma, and P-3m1 corresponding to high ionic conductivity phases, using ab initio molecular dynamics (AIMD), and the results thereof are shown in FIG. 5.

Referring to FIG. 5, it is confirmed that a solid electrolyte substituted with F also appears to have an extremely high ionic conductivity at a high temperature of about 1000 K, but the ionic conductivity decreases as the temperature decreases. However, it may be confirmed that it is calculated to still have a high ionic conductivity of about 1 mS/cm even at room temperature (about 300 K), and accordingly, it may be confirmed that a sufficient electric capacity or battery output may be exhibited even when the solid electrolyte partially substituted with F is applied to an all-solid-state battery that operates at room temperature.

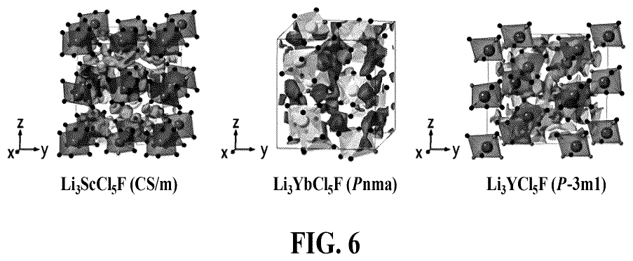

Referring to FIG. 6, as a result of observing isosurfaces for a probability density function of lithium ions in Li₃MCl₅F (M=Sc, Yb, Y), it may be structurally confirmed that a three-dimensional ion path is sufficiently secured so that a smooth diffusion of lithium ions is possible.

According to an embodiment, a composite cathode including the solid electrolyte for the all-solid-state battery represented by Chemical Formula 1, a cathode active material, and a conductive material may be provided.

According to an embodiment, an all-solid-state battery including the solid electrolyte for the all-solid-state battery represented by Chemical Formula 1, a cathode, and an anode may be provided. Here, the cathode may be a composite cathode including the solid electrolyte for the all-solid-state battery.

Hereinafter, the present disclosure will be described in more detail through examples. However, the examples are intended to describe the present disclosure and the scope of the present disclosure is not limited thereby.

### Preparation Example 1: Preparation of Li₃YCl₆₋ₓFₓ (x=0˜1.5) Solid Electrolyte

Solid electrolytes of examples and comparative examples were prepared using a high-energy ball milling method, which will be described below.

### (1) Example 1-1 (F0.5)

LiCl, LiF, and YCl₃ were prepared, and each material was quantitated so that a molar ratio of Li:Y was 3:1 and that a molar ratio of F:Cl was 0.5:5.5, placed in a zirconia container, and then ball-milled at 500 rpm for 20 hours, to prepare a lithium halide-based solid electrolyte.

### (2) Example 1-2 (F1.0)

A lithium halide-based solid electrolyte was prepared in the same manner as in Example 1-1, except that each material was quantitated so that a molar ratio of Li:Y was 3:1 and that a molar ratio of F:Cl was 1.0:5.0.

### (3) Example 1-3 (F1.5)

A lithium halide-based solid electrolyte was prepared in the same manner as in Example 1-1, except that each material was quantitated so that a molar ratio of Li:Y was 3:1 and that a molar ratio of F:Cl was 1.5:4.5.

### (4) Comparative Example 1 (F0.0)

LiCl and YCl₃ were prepared, each material was quantitated so that a molar ratio of Li:Y was 3:1, placed in a zirconia container, and then ball-milled at 500 rpm for 20 hours, to prepare a lithium halide-based solid electrolyte.

### Preparation Example 2: Manufacture of all-Solid-State Battery Including Li₃YCl₆₋ₓFₓ (x=0 to 1.5) Solid Electrolyte

The solid electrolytes of Examples 1-1 to 1-3 and Comparative Example 1, NCM811 (LiNi_{0.8}Co_{0.1}Mn_{0.1}O₂) as a cathode active material, a vapor grown carbon fiber (VGCF) as a carbon conductive material were mixed in a weight ratio of 50:47:3, to prepare a composite cathode. A Li—In alloy and a sulfide-based solid electrolyte (Li_{6.75}Sb_{0.25}Si_{0.75}S₅I) were used as an anode and a solid electrolyte, respectively, together with each prepared composite cathode, to manufacture all-solid-state batteries of Examples 2-1 to 2-3 and Comparative Example 2.

### Experimental Example 1: XRD Measurement of Li₃YCl₆₋ₓFₓ (x=0 to 1.5) Solid Electrolyte

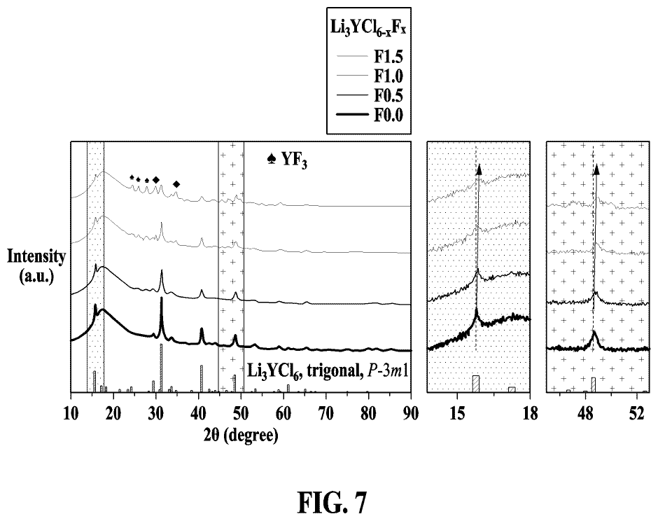

To identify an F-substitutable amount (x) predicted through the calculations of the present disclosure and structural preference based on the F-substitutable amount (x), X-ray diffraction (XRD) patterns were measured for Li₃YCl₆₋ₓFₓ solid electrolytes of Examples 1-1 to 1-3 and Comparative Example 1 synthesized with different values of x, and the results thereof are shown in FIG. 7.

As a result, as predicted by the calculations of FIGS. 1 to 3, it may be confirmed that an initial phase (structural phase of Li₃YCl₆) of P-3m1 may be maintained for Li₃YCl₆₋ₓFₓ when a value of x is less than 1.5 (Comparative Example 1 and Examples 1-1 and 1-2). However, it may be confirmed that when a value of x is 1.5 (Example 1-3), a material is unstable and LiCl and YF₃, decomposition phases, are observed together with an initial structure of P-3m1.

### Experimental Example 2: Measurement of Ionic Conductivity of Li₃YCl₆₋ₓFₓ (x=0 to 1.0) Solid Electrolyte

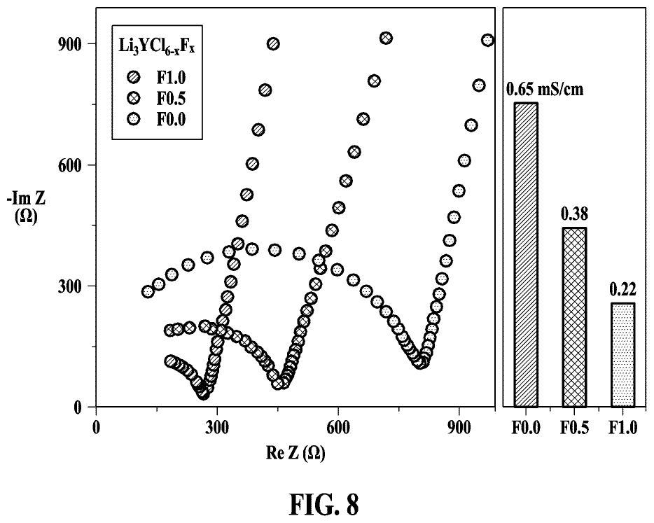

Based on the results of Experimental Example 1, to measure ionic conductivities of the solid electrolytes (Comparative Example 1 and Examples 1-1 and 1-2) in the range of x, in which the initial phase is maintained, according to a change in the value of x, electrochemical impedance spectroscopy (EIS) was performed at 25° C., and the results thereof are shown in FIG. 8.

As a result, similarly to the results of the calculations based on the ab initio molecular dynamics (AIMD) of FIG. 5, the solid electrolyte of Comparative Example 1 (F0.0 in FIG. 8) in which F was not substituted has the highest ionic conductivity, and the ionic conductivity decreases as the range (x) of substitution with F increases. However, even in the solid electrolyte of Example 1-2 (F1.0 in FIG. 8) with the lowest ionic conductivity, an ionic conductivity of 0.22 mS/cm at room temperature (25° C.) is shown, and thus it may be confirmed that Li₃YCl₆₋ₓFₓ has a sufficient ionic conductivity to be used in an all-solid-state battery even when a maximum amount of F in Li₃YCl₆₋ₓFₓ is substituted.

### Experimental Example 3: Measurement of Oxidation Stability of Li₃YCl₆₋ₓFₓ (x=0 to 1.0) Solid Electrolyte

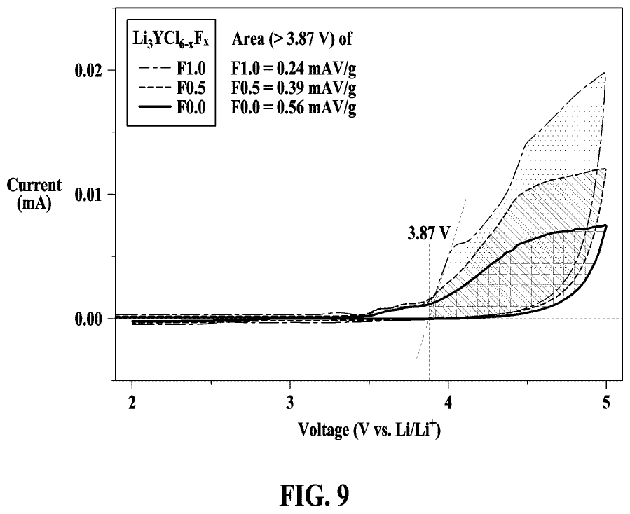

Based on the results of Experimental Example 1, cyclic voltammetry (CV) was performed to compare an oxidation stability according to a change in the value of x for solid electrolytes (Comparative Example 1 and Examples 1-1 and 1-2) in the range of x, in which the initial phase is maintained, and the results thereof are shown in FIG. 9.

As a result, it is confirmed that an oxidation reaction occurred at the same voltage value (3.87 V in FIG. 9) for all the solid electrolytes of Comparative Example 1 and Examples 1-1 and 1-2, similarly to the results predicted through the grand potential diagram in FIG. 4. However, in Examples 1-1 and 1-2 in which F was partially substituted (F0.5 and F1.0 in FIG. 9), it may be confirmed that the oxidation stability is extended to a higher voltage due to a formation of a passive film of LiF or LiYF₄, and confirmed that the degree to which the stability is extended also increases as the substitution range (x) of F increases.

### Experimental Example 4: Measurement of Electric Capacity of All-Solid-State Battery Including Li₃YCl₆₋ₓFₓ (x=0 to 1.0) Solid Electrolyte

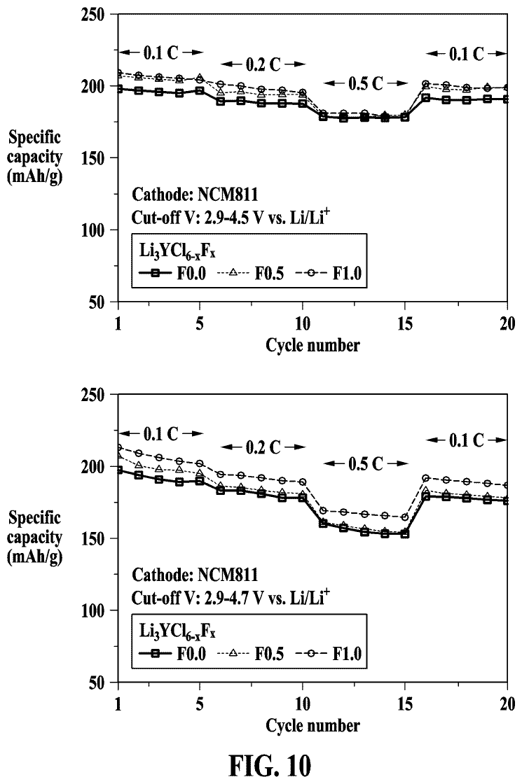

Based on the results of Experimental Example 1, to compare an electric capacity according to a change in the value of x for the all-solid-state batteries (Comparative Example 2 and Examples 2-1 and 2-2) including the solid electrolyte in the range of x in which the initial phase is maintained, cut-off voltages were set to 4.5 V or 4.7 V, and a discharge capacity was measured. Here, measurements were performed at a current density of 0.1 C for 1 to 5 cycles, at a current density of 0.2 C for 6 to 10 cycles, at a current density of 0.5 C for 11 to 15 cycles, and again at a current density of 0.1 C for 16 to 20 cycles, and the results thereof are shown in FIG. 10.

As a result, it may be found that, overall, discharge capacities of the all-solid-state batteries of Examples 2-1 and 2-2 in which F was partially substituted (F0.5 and F1.0 in FIG. 10) are further enhanced in comparison to the all-solid-state battery (F0.0 in FIG. 10) of Comparative Example 2 in which F was not partially substituted, that the discharge capacity increases as the substitution range (x) of F increases, and that such an aspect is more prominent when the cut-off voltage is high (4.7 V in FIG. 10). This indicates that as Cl in the lithium chloride-based solid electrolyte (Li₃YCl₆) is partially substituted with F, it seems that a high electric capacity may be exhibited in comparison to existing Li₃YCl₆ solid electrolytes even at a high voltage due to the improved oxidation stability predicted from the results of the calculations.

Therefore, in the present disclosure, characteristics, such as a structural preference, phase stability, oxidation stability, ionic conductivity, and the like, of the lithium chloride-based solid electrolyte according to the metal element species (M) and F partial substitution range (x) may be predicted in advance based on first principle-based calculations, and an optimal chloride-based solid electrolyte may be designed through corresponding predictions. In addition, consistency with pre-calculation results and usability of an optimally designed chloride-based solid electrolyte may be confirmed through actual experiments.

While the embodiments are described with reference to the drawing, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

### STATEMENT REGARDING PRIOR DISCLOSURES BY THE INVENTOR OR A JOINT INVENTOR

The inventors of the present application have made the following related disclosure in Sooyeon Kim et al., “Fluorine-Substituted Lithium Chloride Solid Electrolytes for High-Voltage All-Solid-State Lithium-Ion Batteries,” ACS Energy Letters, 2023, pages. 38-47 on Dec. 4, 2023. The related disclosure was made less than one year before the effective filing date (Jun. 4, 2024) of the present application. The inventors of the present application include two authors (Yongheum Lee and Seungho Yu) of the disclosure, and does not include four authors (Sooyeon Kim, Kwangnam Kim, Brandon C. Wood and Sang Soo Han) of the disclosure. However, these authors did not make contribution to conception of the invention, and thus are not included in the joint inventors of the present Application. Accordingly, the related disclosure is grace period inventor disclosure, and thus is disqualified from prior art under 35 U.S.C § 102(a)(1) against the present application. See 35 U.S.C § 102(b)(1)(A).

What is claimed is:

1. A solid electrolyte for an all-solid-state battery represented by Chemical Formula 1: 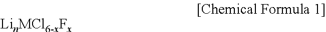
in which M is at least one trivalent metal selected from a group consisting of Al, Ga, In, Tl, Bi, Sc, Lu, Y, Yb, Tm, Er, Ho, Dy, Tb, Gd, Sm, Nd, and La, or at least one tetravalent metal selected from a group consisting of Ti, Zr, and Hf;
n has a value of 3 when M is a trivalent metal, and n has a value of 2 when M is a tetravalent metal; and
x has a value greater than 0 and less than or equal to 1.5.

2. The solid electrolyte of claim 1, wherein M is at least one trivalent metal selected from a group consisting of Al, Ga, In, Tl, Bi, Sc, Lu, Y, Yb, Tm, Er, Ho, Dy, Tb, Gd, Sm, Nd, and La.

3. The solid electrolyte of claim 1, wherein M is at least one trivalent metal selected from a group consisting of In, Tl, Bi, Sc, Lu, Y, Yb, Tm, Er, Ho, Dy, Tb, and Gd.

4. The solid electrolyte of claim 1, wherein
M is at least one trivalent metal selected from a group consisting of In, Tl, Bi, Sc, Lu, Y, Yb, Tm, Er, Ho, Dy, and Tb, and x has a value greater than 0 and less than or equal to 1.5, or
M is Gd that is a trivalent metal, and x has a value greater than 0 and less than or equal to 1.0, and
a value of a decomposition energy of the solid electrolyte is less than or equal to 45 millielectron volts per atom (meV/atom).

5. The solid electrolyte of claim 1, wherein
M is at least one trivalent metal selected from a group consisting of In, Tl, Bi, Sc, Lu, Y, Yb, Tm, Er, and Ho, and x has a value greater than 0 and less than or equal to 1.5, or
M is at least one trivalent metal selected from a group consisting of Dy, Tb, and Gd, and x has a value greater than 0 and less than or equal to 1.0, and
a value of a decomposition energy of the solid electrolyte is less than or equal to 40 meV/atom.

6. The solid electrolyte of claim 1, wherein
M is at least one trivalent metal selected from a group consisting of In, Tl, Sc, Lu, Yb, Tm, and Er, and x has a value greater than 0 and less than or equal to 1.5, or
M is at least one trivalent metal selected from a group consisting of Bi, Y, Ho, Dy, Tb, and Gd, and x has a value greater than 0 and less than or equal to 1.0, and
a value of a decomposition energy of the solid electrolyte is less than or equal to 35 meV/atom.

7. The solid electrolyte of claim 1, wherein
M is In that is a trivalent metal, and x has a value greater than 0 and less than or equal to 1.5,
M is at least one trivalent metal selected from a group consisting of Tl, Bi, Sc, Lu, Y, Yb, Tm, Er, Ho, and Dy, and x has a value greater than 0 and less than or equal to 1.0, or
M is at least one trivalent metal selected from a group consisting of Tb and Gd, and x has a value greater than 0 and less than or equal to 0.5, and
a value of a decomposition energy of the solid electrolyte is less than or equal to 30 meV/atom.

8. The solid electrolyte of claim 1, wherein
M is at least one trivalent metal selected from a group consisting of In, Tl, Lu, Yb, Tm, and Er, and x has a value greater than 0 and less than or equal to 1.0, or
M is at least one trivalent metal selected from a group consisting of Bi, Sc, Y, Ho, Dy, Tb, and Gd, and x has a value greater than 0 and less than or equal to 0.5, and
a value of a decomposition energy of the solid electrolyte is less than or equal to 25 meV/atom.

9. The solid electrolyte of claim 1, wherein
M is at least one trivalent metal selected from a group consisting of Sc, Yb, and Y, and
x has a value greater than 0 and less than or equal to 1.5.

10. The solid electrolyte of claim 1, wherein
M is Y that is a trivalent metal, and
x has a value greater than 0 and less than or equal to 1.5.

11. A composite cathode for an all-solid-state battery, the composite cathode comprising
the solid electrolyte of claim 1;
a cathode active material; and
a conductive material.

12. An all-solid-state battery comprising:
the solid electrolyte of claim 1;
a cathode; and
an anode.
